(19) United States
(12) Patent Application Publication
(10) Pub. No.: US 2004/0037069 A1
(43) Pub. Date: Feb. 26, 2004

(54) Electronic candle

(76) Inventor: Leigh George Blackbourn, Boston (GB)

Correspondence Address: Supervisor, Patent Prosecution Services, PIPER RUDNICK LLP, 1200 Nineteenth Street, N.W., Washington, DC, 20036-2412, US

(21) Appl. No.: 10/226,322

(22) Filed: Aug. 23, 2002

(51) Int. Cl. F21L 19/00

(52) U.S. Cl. 362/161; 362/392

(57) ABSTRACT

A electronic candle comprising at least two light sources located within a housing with a diffusing means. The two lights sources are intermittently switched on and off so that they provide the impression of a naked flame. The diffusing means act to enhance the illusion. Together with a rechargeable internal power supply, the electronic candle offers a safe alternative to a natural candle.

### FIELD OF THE INVENTION

This invention relates to electrically powered candle light sources.

### BACKGROUND OF THE INVENTION

For many hundreds of years wax candles have been used as a convenient source of light with the light being provided by a naked flame as it burns the body of the wax. With the event of gas powered and later on, electric powered light sources the level of candle use has decreased. However candles have remained a popular alternative source of light. One possible reason for this is the aesthetic quality of a naked flame and the unique style of lighting it provides.

Just as the naked flame of the candle provides aesthetic benefits it also provides all the dangers associated with fire. It is because of these dangers that candles should not be left unattended for extended periods of time or when small children are about. Therefore there is a desire for light sources that provide light of a similar aesthetic quality to that of a naked flame but without the inherent dangers.

One way in which this has been done is by using a constant electrical light source together with a means for periodically interrupting the light given off and by such means creating the flickering light effect reminiscent of a naked flame. The periodic interruption is usually facilitated by a rotating disc or the like, which must be hidden within a suitable housing to maintain the illusion, this to some extent limits the potential designs possible.

Another way of providing an artificial flame is in the form of a specialised light bulb with more than one light filament, wherein the filaments turn on and off independently of one another so as to give the illusion of a flickering flame. These light bulbs tend to be much more expensive that standard light bulbs due to the more complicated filament arrangement. Also, in the event that one of the filaments breaks, an event which is made more likely by the continuous switching on and off of the filaments, the whole bulb must be replaced if the aesthetic quality is to be maintained.

Neither of these examples however, provides the shear portability that a wax candle allows, due to their reliance on mains power.

### SUMMARY OF THE INVENTION

The invention provides an electronic candle comprising a housing with a diffusing means, at least two light sources and a switching circuit, wherein the switching circuit is arranged to switch at least one of the light sources on and off, whereby the light sources radiate via the diffusing means to give the visual effect of a candle flame.

Preferably, one light source is illuminated constantly while the candle is operating, while the other light source is switched on and off at regular or irregular intervals, for example at a frequency of around 1 Hz. However, it is possible for both light sources to be switched on and off to create the flickering effect, although it is preferred that, at any given time, at least one of the light sources is illuminated.

The electronic candle preferably comprises an internal battery as a power source.

As the aesthetic quality of the electronic candle is important, it is understood that it is preferable for the housing to have the appearance of a wax candle, with the diffusing means forming the equivalent of the wick on a wax candle.

The housing may be formed from a rigid plastics material with a high enough melting point to cope with the heat generated by the internal working of the electronic candle. It is understood that a plastic available in many colours is advantageous so as to provide a wide choice of candle colours as with normal wax candles.

It is preferred that the diffusing means will be translucent so as to enhance the flickering effect produced by the light sources. The diffusing means may be made separately from the housing means. The diffusing means may be made from frosted glass.

In a preferred embodiment the candles power source will be a rechargeable, internal battery, whereby the candle may be connected to a battery charger so that the candle's power source may be renewed repeatedly. Each candle may have a docking port arranged to receive a docking pin from the charger. The docking pin is arranged to supply a power supply to facilitate the recharging of the candles internal power supply.

Preferably, the docking port could also be arranged so that, upon connection to the docking pin the candle is switched off. Advantageously, a ‘dummy’ docking pin could be used to turn the candle off when it is fully charged but is not needed. Therefore by inserting and removing the dummy pin the candle can be turned of and off as desired.

Alternatively, the battery charger may itself have an aesthetically suitable appearance, such that candles can be connected to the charger for recharging and still function as candles.

A preferred type of light source which may be used in the electronic candles are light emitting diodes (LEDs). The flickering effect provided by the electronic candles may be created by only two light sources, however it may be advantageous to use more that two light sources to create the flickering effect.

### BRIEF DESCRIPTION OF THE DRAWINGS

In the drawings, which illustrate a preferred embodiment of the invention:

FIG. 1 shows a side view of the preferred embodiment of the electronic candle;

FIG. 2 shows a plan view of the preferred embodiment of the electronic candle;

FIG. 3 is a cross-sectional view of the electronic candle;

FIG. 4 shows the docking of the electronic candle with a charging means;

FIG. 5 shows the schematic of the internal workings of the candle.

### DETAILED DESCRIPTION OF THE ILLUSTRATED EMBODIMENT

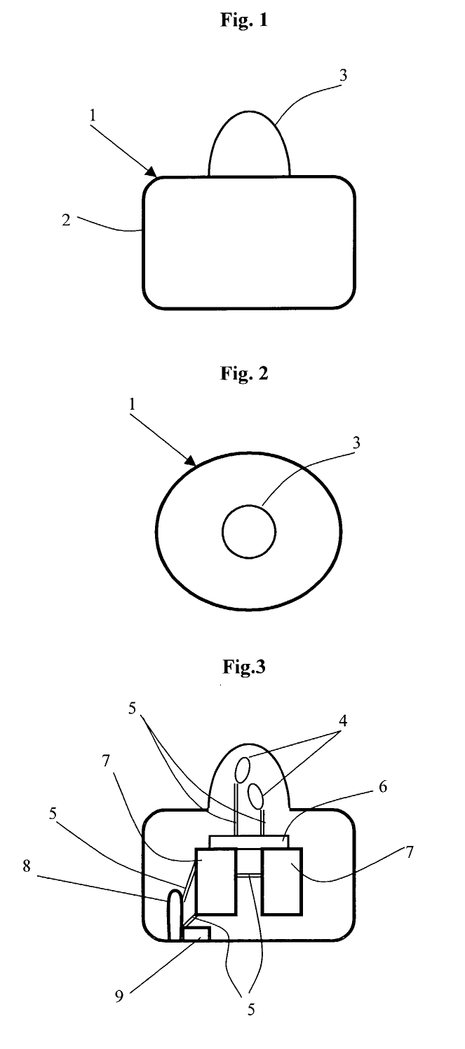

FIG. 1 shows a preferred embodiment of the electronic candle, although this has the appearance of a ‘tea-light’ candle it will be understood from the invention that other shapes of candle are possible.

It can be seen from FIGS. 1 and 2 that the electronic 1 candle has two main regions, namely the housing means 2, which holds the majority of the internal electronics of the candle, and the diffusing means 3, which is positioned proximate to the light sources 4. It is also evident from the figures that the electronic candle 1 is completely self-contained and as such can be used in an identical manner to normal wax candles.

With the benefit of FIG. 3 a preferred internal arrangement for the candle can be seen. The housing means 2 contains the majority of the electronic components comprising; the rechargeable battery power source 7, the switching circuitry 6, the candle on/off switch 9, the charger docking port 8 and the wires 5 connecting them all. The light sources 4, as can be seen in FIG. 3, are positioned proximate to the diffusing means 3 in order that the majority of light given off is incident upon the diffusing means 3. It will be understood from the invention that this internal arrangement is not the only way in which the components necessary to operate the electronic candle 1 may be arranged.

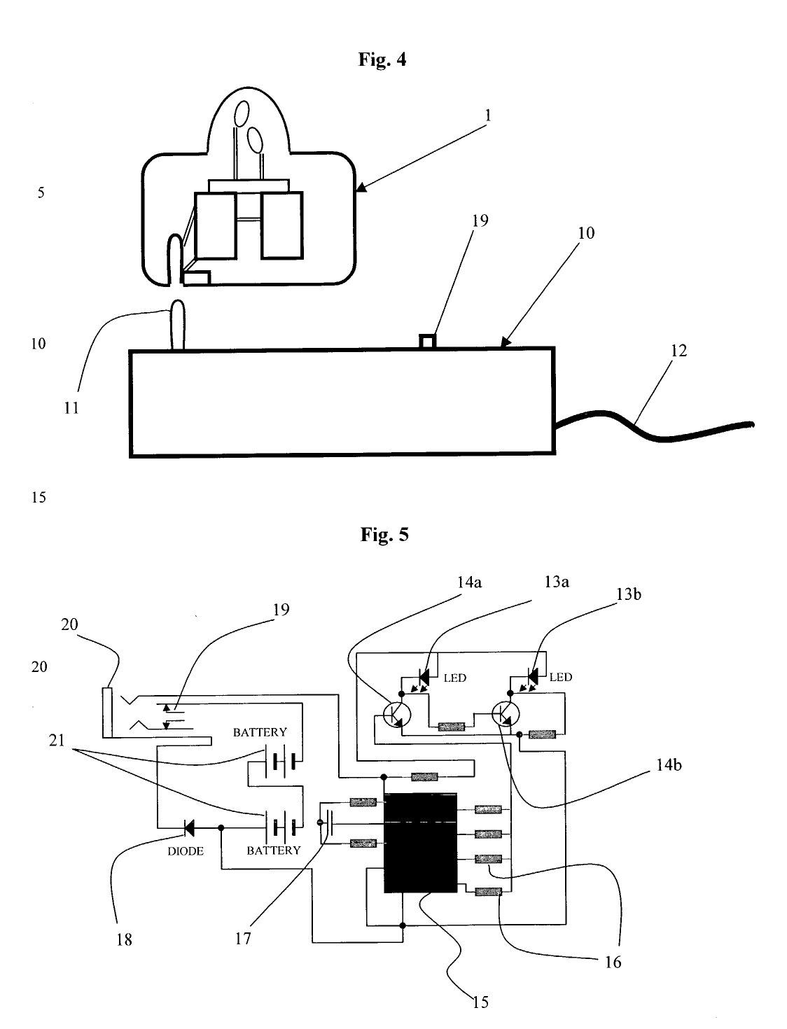

FIG. 4 illustrates the interaction between the electronic candle 1 and a charging means and shows the complementary nature of the docking port 8 on the electronic candle 1 and the docking pin 11 on the charging means 10. Upon coupling of the docking port 8 and the docking pin 11 the charging of the internal battery source 7 of the electronic candle 1 may be initiated. Also, a diode 18 is arranged to turn on when the candle is being charged. Although only one docking pin 11 is shown in the figure it will be understood that more than one could be present on charging means 10, thus allowing for more than one electronic candle 1 to be charged simultaneously.

FIG. 5 shows a schematic of the preferred internal arrangement of the electric candle. In this embodiment the system has two different circuits, the battery circuit and the LED circuit. Also this embodiment has two different states, the first is when the candle is docked on the charging means 10 and the second is when it is not docked.

In the first state the docking pin 11 of the charging means 10 connects with the docking port 8 of the candle 1, when this happens the docking pin makes contact with contact 20 which completes the battery circuit wherein the batteries are recharged by the charging means 10. The battery circuit comprises two NICAD batteries 21 and a diode 18, which indicates when the circuit is complete and thus the batteries 21 are being charged. Also, in this state the LED circuit is switched off by the interaction of the docking pin 11 with a switching means contact 19 of the candle on/off switch (not shown).

In the second state the battery circuit supplies power to the LED circuit, which comprises; two light emitting diodes 13a and 13b as the light sources, two transistors 14a and 14b, several resistors 16 to balance the circuit, a capacitor 17 to smooth of the any voltage changes and a binary counter 15 (74CHC4060) which provides a switching signal to the first transistor 14a to change the first LED 13a between an on state and an off state after a pre-determined count interval. The other LED 13b is powered continuously while the candle device is switched on. The combination of the continuous light from one LED and intermittent illumination from the other LED, when viewed through the translucent diffuser, gives the effect of a flickering candle, especially when viewed with the candle device placed inside a second, larger diffuser, for example a frosted glass cover.

I claim:

1. An electronic candle comprising a housing with a diffusing means, at least two light sources and a switching circuit, wherein the switching circuit is arranged to switch at least one of the light sources on and off, whereby the light sources radiate via the diffusing means to give the visual effect of a candle flame.

2. A candle according to claim 1, wherein one light source is illuminated constantly while the candle is operating, while the other light source is switched on and off at regular or irregular intervals.

3. A candle according to claim 1, wherein both light sources are switched on and off to create the flickering effect.

4. A candle according to claim 1, comprising an internal battery as a power source.

5. A candle according to claim 4, wherein the internal battery is rechargeable.

6. A candle according to claim 5, further comprising a docking port arranged to receive a docking pin from an external charger.

7. A candle according to claim 6, wherein the docking port is adapted so that, upon connection to the docking pin the candle is switched off.

8. A candle according to claim 1, wherein the housing has the appearance of a wax candle and the diffusing means forms the equivalent of the wick on a wax candle.

9. A candle according to claim 1, wherein the housing is formed from a rigid plastics material with a melting point sufficient to cope with the heat generated by the internal working of the electronic candle.

10. A candle according to claim 1, wherein the diffusing means is translucent, so as to enhance the flickering effect produced by the light sources.

11. A candle according to claim 10, wherein the diffusing means is made from frosted glass.

12. A candle according to claim 1, wherein each light source comprises a light emitting diode (LED).
